(19) United States
(12) Patent Application Publication
(10) Pub. No.: US 2016/0041683 A1
(43) Pub. Date: Feb. 11, 2016

(54) METHOD AND APPARATUS FOR DISTINGUISHING SCREEN HOLD FROM SCREEN TOUCH

(71) Applicants: Zhigang ZHANG, (US); Jun XU, (US); Yanfeng ZHANG, (US); Xiaojun MA, (US); THOMSON LICENSING, Issy-les-Moulineaux (FR)

(72) Inventors: Xiaojun Ma, Beijing (CN); Jun Xu, Beijing (CN); Yanfeng Zhang, Beijing (CN); Zhigang Zhang, Beijing (CN)

(73) Assignee: THOMSON LICENSING, Issy de Moulineaux (FR)

(21) Appl. No.: 14/782,860

(22) PCT Filed: Jun. 19, 2013
(86) PCT No.: PCT/CN13/77505

§ 371 Date: Oct. 7, 2015

(51) Int. Cl. G06F 3/041

(52) U.S. Cl. CPC G06F 3/0416; G06F 3/0414; G06F 3/0412; G06F 2203/04106

(57) ABSTRACT

A touch screen enabled device of the present invention includes at least a display screen, a frame bordering the display screen and at least one touch sensor located in the device such that when pressure is applied to at least a portion of the frame proximate the at least one touch sensor, the pressure is sensed by the at least one touch sensor. In a touch screen enabled device of the present invention, the activation of a touch sensor located proximate at least a portion of a frame of the touch screen enabled device is electrically sensed and a touch screen functionality of at least a portion of a screen of the touch screen enabled device proximate the activated touch sensor is disabled.

### FIELD OF THE INVENTION

The present invention generally relates to touch screens in electronic devices and, more particularly, to a method and apparatus for distinguishing a screen hold from a screen touch.

### BACKGROUND OF THE INVENTION

The integration of touch screens in electronic devices such as mobile terminals has achieved great success. A big advantage of the touch screen is that it makes interaction with a device via a screen much more simple and convenient. In recent devices however, a trend of the design is to minimize the frame around a screen to maximize a screen size and to make the device look more aesthetically pleasing.

Such recent designs however come with a drawback. More specifically, when a user holds such a touch screen device with a large screen and minimal frame size, the screen may be inadvertently touched by the user, unintentionally activating an application or functionality associated with a touch of the screen of the electronic device as depicted in FIG. 1.

### SUMMARY OF THE INVENTION

Embodiments of the present invention address the deficiencies of the prior art by providing a method and apparatus for distinguishing a screen hold from a screen touch.

In an embodiment of the present invention a method includes electrically sensing the activation of a touch sensor located proximate at least a portion of a frame of a touch screen enabled device and disabling a touch screen functionality of at least a portion of a screen of the touch screen enabled device proximate the activated touch sensor. The method can optionally further include relocating icons located in the disabled portion of the screen to an area on the screen outside of the disabled portion of the screen.

In an alternate embodiment of the present invention, touch screen enabled device includes a display screen, a frame bordering the display screen and at least one touch sensor located in the device such that when pressure is applied to at least a portion of the frame proximate the at least one touch sensor, the pressure is sensed by the at least one touch sensor. In a touch screen enabled device of the present invention, the activation of a touch sensor located on at least a portion of a frame of a touch screen enabled device is electrically sensed and a touch screen functionality of at least a portion of a screen of the touch screen enabled device proximate the activated touch sensor is disabled.

### BRIEF DESCRIPTION OF THE DRAWINGS

The teachings of the present invention can be readily understood by considering the following detailed description in conjunction with the accompanying drawings, in which:

FIG. 1 depicts a prior art mobile communications device;

FIG. 2 depicts a high level block diagram of a mobile communications device for distinguishing a screen hold from a screen touch in accordance with an embodiment of the present invention;

FIG. 3 depicts a high level block diagram of a mobile communications device for distinguishing a screen hold from a screen touch in accordance with an alternate embodiment of the present invention and

FIG. 4 depicts a flow diagram of a method for distinguishing a screen hold from a screen touch in accordance with an embodiment of the present invention.

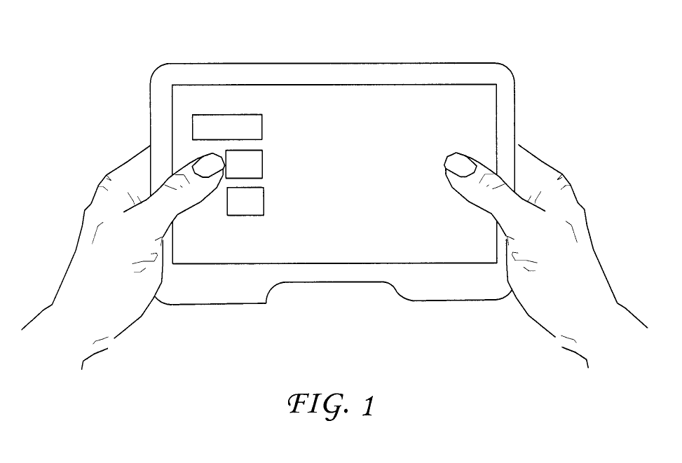

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method and apparatus for distinguishing a screen hold from a screen touch. Although the present invention will be described primarily with reference to a mobile communications device, the specific embodiments of the present invention should not be treated as limiting the scope of the invention. It will be appreciated by those skilled in the art and informed by the teachings of the present invention that the concepts of the present invention can be advantageously applied to any device which has touch screen functionality.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudo code, and the like represent various processes which may be substantially represented in computer readable media and so executed by a computer or processor, whether or not such computer or processor is explicitly shown.

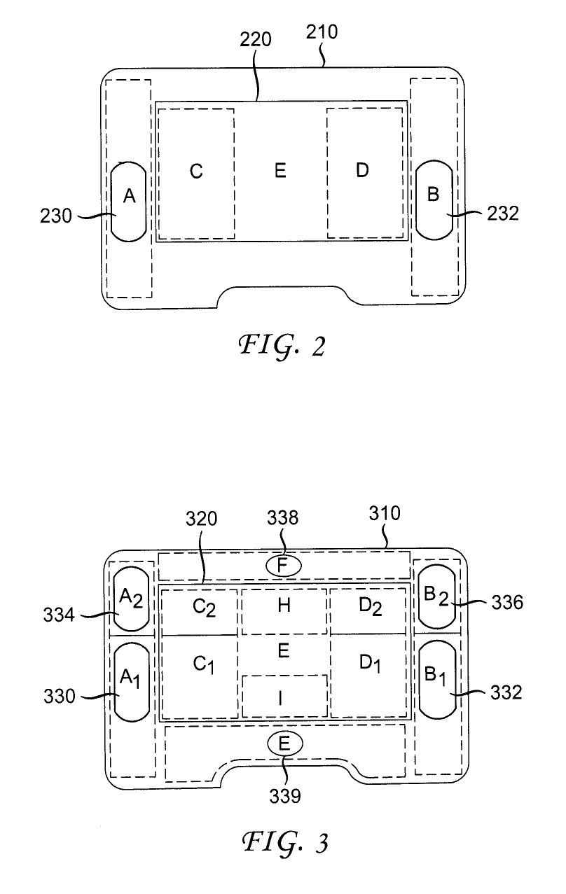

FIG. 2 depicts a high level block diagram of a touch screen enabled device, illustratively a mobile communications device, for distinguishing a screen hold from a screen touch in accordance with an embodiment of the present invention. The mobile communications device 200 of FIG. 2 illustratively comprises a tablet including a frame 210, a screen 220 having touch screen functionality, and touch sensors (illustratively two touch sensors) 230, 232. The mobile communications device 200 of FIG. 2 is illustratively divided into five (5) sections A, B, C, D and E for descriptive purposes. In the embodiment of the mobile communications device 200 of FIG. 2, section A illustratively represents a left portion of the frame 210, section B illustratively represents a right portion of the frame 210, section C represents a left portion of the screen 220, section D represents a right portion of the screen 220 and section E represents a remaining portion of the screen 220 of the mobile communications device 200.

In the embodiment of the present invention of FIG. 2, sections A and B of the mobile communications device 200 include touch sensors 230, 232. In one embodiment of the present invention the touch sensors 230, 232 can comprise transducers that are sensitive to touch, force, or pressure such as tactile sensors. In the embodiment of the present invention of FIG. 2, the touch sensors 230, 232 in sections A and B of the mobile communications device 200 are used to detect whether the mobile communications device 200 is being held by applying pressure to at least one of sections A and B. More specifically and as depicted in FIG. 2, when a user is holding the mobile communications device 200, for example, by applying pressure to section A and/or section B using the users hand or hands, the touch sensor(s) 230 and/or 232 senses the pressure being applied to those sections and the sensor(s) 230 and/or 232 is activated. Although in FIG. 2 and other similar embodiments of the present invention illustratively presented and described herein it appears that the touch sensors of the present invention are located on a frame of a user device, it should be noted that in accordance with various embodiments of the present invention, at least one touch sensor is located in a touch screen enabled user device such that when pressure is applied to at least a portion of the frame of the touch screen user device proximate the at least one touch sensor, the pressure is sensed by the at least one touch sensor.

In accordance with embodiments of the present invention, the configuration of the mobile communications device 200 is altered in response to the activation of at least one of the sensors 230, 232 such that pressure applied to a portion of the screen 220 by a holding device, for example a user's hand(s), which is intended to only hold the mobile communications device 200, is not interpreted by the mobile communications device 200 as a touch intended to control the functionality of the mobile communications device or a touch intended to launch an application via an icon on the screen 220.

More specifically, in one embodiment of the present invention, when a sensor is activated a touch screen functionality of a section of the screen 220 proximate to the activated sensor is disabled such that any pressure or touch in that touch screen disabled section of the screen 220 is assumed to be associated with a holding of the touch screen enabled device and fails to cause any response or result in any action from the mobile communications device 200. For example and with reference to FIG. 2, if a user's hand activates sensor 230 in section A by applying pressure when holding the mobile communications device 200 via the left portion of the frame 210, in one embodiment of the present invention, touch screen functionality in section C is disabled. Similarly, and referring again to FIG. 2, if a user's hand activates sensor 232 in section B by applying pressure when holding the mobile communications device 200 via the right portion of the frame 210, in one embodiment of the present invention, touch screen functionality in section D is disabled for as long as sensor 232 is activated. In one embodiment of the present invention, the touch screen functionality of a portion of the screen proximate to an activated sensor is disabled for as long as the activation of a respective sensor. In alternate embodiments of the present invention described below, the touch screen functionality in a portion of a screen proximate to an activated sensor is only disabled for touches coincident with the activation of the activated sensor. In yet alternate embodiments of the present invention described below, the touch screen functionality in a portion of a screen proximate to an activated sensor is only disabled for touches coincident with the activation of the activated sensor if the touches coincident with the activation of the activated sensor are longer than a predetermined time period. (Described in further detail below).

It should be noted that the sections A, B, C, D, E depicted in the embodiment of FIG. 2 are only illustrative and in alternate embodiments of the present invention, sections A, B, C, D, E can encompass different portions of a screen and can comprise different sizes than those depicted in FIG. 2. For example, in alternate embodiments of the present invention, sections A, B, C, D, E can be sized according to a space on the screen between a frame section of a mobile communications device of the present invention and an application icon closest to that frame section. As such, when a sensor on a frame section of the mobile communications device is activated, the touch screen functionality of that section encompassing the space on the screen between a frame section of a mobile communications device of the present invention and an application icon closest to that frame section is disabled.

In various embodiments of the present invention, the amount of force needed to activate a touch sensor switch, such as the sensors 230, 232 of FIG. 2, can be adjusted to make the triggering of the sensors more or less sensitive depending on the application and the size or strength of a user of a touch screen enabled device.

In yet an alternate embodiment of the present invention, there can be more than one touch sensor on a portion of a frame of a mobile communications device and corresponding sections associated with the touch sensors. For example, FIG. 3 depicts a high level block diagram of a mobile communications device for distinguishing a screen hold from a screen touch in accordance with an alternate embodiment of the present invention. The mobile communications device 300 of FIG. 3 illustratively comprises a tablet including a frame 310, a screen 320 having touch screen functionality, and touch sensors (illustratively four touch sensors) 330, 332, 334 and 336. The mobile communications device 300 of FIG. 3 is illustratively divided into five (9) sections A1, A2, B1, B2, C1, C2, D1, D2 and E for descriptive purposes. In the embodiment of the mobile communications device 300 of FIG. 3, section A2 illustratively represents a top left portion of the frame 310, section A1 illustratively represents a bottom left portion of the frame 310, section B2 illustratively represents a right top portion of the frame 310, section B1 illustratively represents a right bottom portion of the frame 310, section C2 represents a left top portion of the screen 320, section C1 represents a left bottom portion of the screen 320, section D2 represents a right top portion of the screen 320, section D1 represents a right bottom portion of the screen 320 and section E represents a remaining portion of the screen 320 of the mobile communications device 300.

In the embodiment of the present invention of FIG. 3, sections A1, A2, B1 and B2 of the mobile communications device 300 include touch sensors 330, 334, 332 and 336. In the embodiment of the present invention of FIG. 3, the touch sensors 330, 334, 332 and 336 in sections A1, A2, B1 and B2 of the mobile communications device 300 are used to detect whether the mobile communications device 300 is being held by applying pressure to at least one of the sections A1, A2, B1 and B2. More specifically and as depicted in FIG. 3, when a user is holding the mobile communications device 300, for example, by applying pressure to at least one of sections A1, A2, B1 and B2 using the users hand or hands (or any other device), corresponding one of the touch sensor(s) 330, 334, 332, 336 senses the pressure being applied to that section(s) and the sensor(s) 330, 334, 332, 336 is activated. In accordance with embodiments of the present invention, the configuration of the mobile communications device 300 is altered in response to the activation of at least one of the sensors 330, 334, 332, 336 such that pressure applied to a portion of the screen 320 which is intended to only hold the mobile communications device 300 is not interpreted by the mobile communications device 300 as a touch intended to control the functionality of the mobile communications device or a touch intended to launch an application on the screen 320.

More specifically, in one embodiment of the present invention, when a sensor is activated a touch screen functionality of a section of the screen 320 proximate to the activated sensor is disabled such that any pressure or touch in that disabled section of the screen 320 fails to cause any response or result in any action from the mobile communications device 300. For example and with reference to FIG. 3, if a user's hand activates sensor 330 in section A1 by applying pressure when holding the mobile communications device 300 via the left bottom portion of the frame 310, in one embodiment of the present invention, touch screen functionality in section C1 is disabled. Similarly, and referring again to FIG. 3, if a user's hand activates sensor 332 in section B1 by applying pressure when holding the mobile communications device 300 via the right bottom portion of the frame 310, in one embodiment of the present invention, touch screen functionality in section D1 is disabled.

It should be noted that although in FIGS. 2 and 3 above, the touch sensors and sections seem to correspond in number and location, in alternate embodiments of the present invention, the touch sensors and sections do not have to have a one to one relationship. That is, there can be more sections than sensors or more sensors than sections and the sensors and sections do not have to correspond in location. In addition, although in FIGS. 2 and 3 it is depicted that a user is holding the mobile communications device, the same principles of the present invention apply if something other than a user's hand(s) is used to apply pressure to the frame of the mobile communications device to stabilize or hold the mobile communications device.

In addition, in various embodiments of the present invention a mobile communications device in accordance with the present invention can further include touch sensors and associated sections in locations proximate other portions of a frame of a mobile communications device. For example and referring back to FIG. 3, the mobile communications device 300 further comprises sections F, G, H and I. In the embodiment of FIG. 3, section F illustratively represents a top portion of the frame 310 of the mobile communications device 300, section G illustratively represents a bottom portion of the frame 310, section H illustratively represents a top portion of the screen 320 and section I illustratively represents a bottom portion of the screen 320 of the mobile communications device 300. In the embodiment of FIG. 3, sections F and G of the mobile communications device 300 include touch sensors 338, 339. Although in FIG. 3, sections H and I illustratively comprise a portion of the screen not overlapping sections C2, D2, C1, D1 and E, it should be noted that in alternate embodiments of the present invention, sections of present invention as described herein can overlap.

As described above, in embodiments of the present invention, the configuration of a touch screen enabled device is altered in response to the activation of a touch sensor such that pressure applied to a portion of the screen of a touch screen enabled device which is intended to only hold the touch screen enabled device is not interpreted by the touch screen enabled device as a touch intended to control the functionality of the touch screen enabled device or a touch intended to launch an application via an icon on the screen. As described above, in one embodiment of the present invention, when a touch sensor is activated a touch screen functionality of a section of the screen of a touch screen enabled device proximate to the activated sensor is disabled such that any pressure or touching of the screen in that disabled section of the screen fails to cause any response or result in any action from the touch screen enabled device.

In an alternate embodiment of the present invention, when a touch sensor is activated the configuration of a touch screen enabled device is altered by moving icons on a screen of the touch screen enabled device intended to launch applications or activate a response from the touch screen enabled device away from the area proximate the activated sensor to avoid the inadvertent triggering of such icons and to move such icons to an active area of the screen. More specifically, in one embodiment of the present invention, when a touch sensor is activated as described above, icons on a screen of the touch screen enabled device intended to launch applications or activate a response from the touch screen enabled device are moved out of a portion of the screen in which touch screen functionality is disabled in response to the activation of the touch sensor(s) as described above.

In alternate embodiments of the present invention, the touch screen functionality in a portion of a screen of a touch screen enabled device proximate to an activated sensor is only disabled for touches coincident with the activation of the activated sensor. That is, in such an embodiment, any touches in a portion of a screen proximate to an activated sensor coincident with the activation of the activated sensor are considered to be associated with the holding of the touch screen enabled device and such touches result in no action because the touch screen functionality of that portion of the screen has been disabled in accordance with the present invention. More specifically, in an embodiment of the present invention, touch screen functionality for a portion of a screen of a touch screen enabled device proximate an activated sensor is disabled at the instance a sensor is activated or, in an alternate embodiment of the present invention, from the instance a sensor is activated and for a short period of time after a sensor is activated, for example one (1) or two (2) seconds after a sensor is activated. In such embodiments, touches on the portions of the screen of a touch screen enabled device proximate an activated sensor that are made after the instance a sensor is activated, in the first described embodiment, or more than one (1) or two (2) seconds after a respective sensor is activated, in the second described embodiment, function as touches on the screen of a touch screen enabled device normally do.

Even further, in embodiments of the present invention as those described above, the touch screen functionality in a portion of a screen proximate to an activated sensor is only disabled for touches coincident with the activation of the activated sensor if the touches coincident with the activation of the activated sensor are longer than a predetermined time period. That is, in such an embodiment of the present invention, any touches in a portion of a screen proximate to an activated sensor coincident with the activation of the activated sensor are only considered to be associated with the holding of the touch screen enabled device or separate holds if such touches last longer than a predetermined time period. More specifically, in one embodiment of the present invention, touch screen functionality for a portion of a screen of a touch screen enabled device proximate an activated sensor is disabled for touches occurring at the instance a sensor is activated only if a touch is sensed on the screen for longer than a predetermined period of time. For example, if a touch sensor of the present invention is activated by, for example, a user holding the frame of a touch screen enabled device, a touch in a portion of a screen proximate to an activated sensor is only considered a hold if the touch is sensed in that portion of the screen for longer than, for example one (1) or two (2) seconds. If the touch is sensed in that portion of the screen for a time period shorter than the predetermined period of time, then that touch can be considered a touch not associated with a holding of the touch screen enabled device and touch screen functionality for that touch is not disabled.

In yet an alternate embodiment of the present invention, the touch response of a touch screen of a touch screen enabled device is delayed for a predetermined period of time, such that if a touch on the screen of a touch screen enabled device is sensed for longer than the predetermined period of time, the touch is considered a hold and a configuration of the mobile communications device is altered as described above. For example, in one embodiment of the present invention, in response to a touch on the touch screen being sensed for longer than the predetermined period of time, a touch screen functionality of a section of the screen of the touch screen enabled device proximate to the area of the touch is disabled. In an alternate embodiment of the present invention, in response to a touch on the touch screen being sensed for longer than the predetermined period of time, icons on a screen of the touch screen enabled device intended to launch applications or activate a response from the touch screen enabled device are moved away from the area proximate the activated sensor.

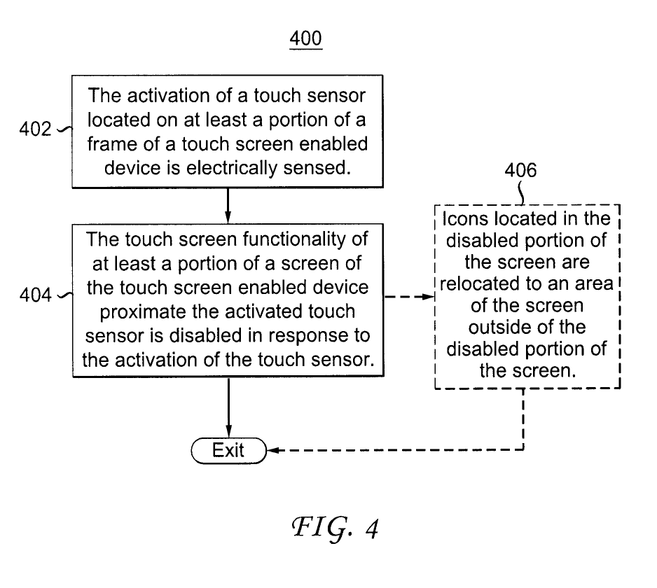

FIG. 4 depicts a flow diagram of a method for distinguishing a screen hold from a screen touch in accordance with an embodiment of the present invention. The method 400 of FIG. 4 illustratively begins at step 402 during which the activation of a touch sensor located on at least a portion of a frame of a touch screen enabled device is electrically sensed. The method 400 then proceeds to step 404.

At step 404, the touch screen functionality of at least a portion of a screen of the touch screen enabled device proximate the activated touch sensor is disabled in response to the activation of the touch sensor. The method 400 can proceed to optional step 406 or can then be exited.

At optional step 406, icons located in the disabled portion of the screen are relocated to an area of the screen outside of the disabled portion of the screen.

Having described various embodiments of a method and apparatus for distinguishing a screen hold from a screen touch (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method, comprising:
electrically sensing the activation of a touch sensor located proximate at least a portion of a frame of a touch screen enabled device; and
disabling a touch screen functionality of at least a portion of a screen of the touch screen enabled device proximate the activated touch sensor.

2. The method of claim 1, comprising relocating icons located in the disabled portion of the screen to an area on the screen outside of the disabled portion of the screen.

3. The method of claim 1, comprising disabling a touch screen functionality of at least a portion of a screen of the touch screen enabled device proximate the activated touch sensor for as long as the activated touch sensor is activated.

4. The method of claim 1, comprising disabling a touch screen functionality of at least a portion of a screen of the touch screen enabled device proximate the activated touch sensor for touches of the screen coincident with the activation of the activated touch sensor.

5. The method of claim 4, comprising disabling a touch screen functionality of at least a portion of a screen of the touch screen enabled device proximate the activated touch sensor for touches of the screen coincident with the activation of the activated touch sensor that exceed a predetermined period of time.

6. The method of claim 1, wherein an amount of force required to activate the touch sensor is adjustable.

7. The method of claim 1, wherein a touch screen functionality of at least a portion of a screen of the touch screen enabled device proximate the activated touch sensor is only disabled for touches of the screen that exceed a predetermined period of time.

8. The method of claim 1, wherein disabling a touch screen functionality of at least a portion of a screen of the touch screen enabled device proximate the activated touch sensor comprises delaying the touch screen response of the screen.

9. An apparatus, comprising:
a display screen;
a frame bordering the display screen; and
at least one touch sensor located in the apparatus such that when pressure is applied to at least a portion of the frame proximate the at least one touch sensor, the pressure is sensed by the at least one touch sensor;
said apparatus having touch screen functionality and configured to:
electrically sense the activation of a touch sensor located on at least a portion of a frame of a touch screen enabled device; and
disable a touch screen functionality of at least a portion of a screen of the touch screen enabled device proximate the activated touch sensor.

10. The apparatus of claim 9, wherein icons located in a disabled portion of the display screen are relocated to portion of the display screen outside of the disabled portion.

11. The apparatus of claim 9, wherein a touch screen functionality of at least a portion of the display screen proximate an activated touch sensor is disabled for as long as the activated touch sensor is activated.

12. The apparatus of claim 1, wherein a touch screen functionality of at least a portion of the display screen proximate an activated touch sensor is disabled for touches of the display screen coincident with the activation of the activated touch sensor.

13. The apparatus of claim 12, wherein a touch screen functionality of at least a portion of the display screen proximate an activated touch sensor is disabled for touches of the screen coincident with the activation of the activated touch sensor that exceed a predetermined period of time.

14. The apparatus of claim 9, wherein an amount of force required to activate the at least one touch sensor is adjustable.

15. The apparatus of claim 9, wherein a touch screen functionality of at least a portion of the display screen proximate an activated touch sensor is disabled for touches of the screen that exceed a predetermined period of time.

16. The apparatus of claim 9, wherein disabling a touch screen functionality of at least a portion of the display screen proximate the activated touch sensor comprises delaying the touch screen response of the display screen.
